(19) United States
(12) Patent Application Publication
(10) Pub. No.: US 2024/0421441 A1
(43) Pub. Date: Dec. 19, 2024

(54) Battery Pack and Jig for Battery Pack Manufacture

(71) Applicant: Enconnex LLC, Reno, NV (US)

(72) Inventors: Joel King, Reno, NV (US); Benjamin Luke, Sparks, NV (US)

(21) Appl. No.: 18/335,962

(22) Filed: Jun. 15, 2023

(51) Int. Cl. H01M 50/509; H01M 10/04; H01M 50/213; H01M 50/289; H01M 50/296; H01M 50/507

(52) U.S. Cl. CPC H01M 50/509; H01M 10/0404; H01M 50/213; H01M 50/289; H01M 50/296; H01M 50/507

(57) ABSTRACT

A battery pack designed for disassembly and maintenance comprises a plurality of battery cells. Each battery cell has a set of battery terminals, and ones of the set of battery terminals are connected electrically to supply collective power. A set of battery pack terminals receives and conveys the collective power. The battery pack includes a flexible outer sheathing secured around it that rigidifies the battery pack. For example, one or more foils may connect ones of the sets of battery terminals, and layers of electrical insulation may be included within the outer sheathing, for example, interposed between the anodes and the cathodes of the battery cells and the foils. The outer sheathing may comprise shrink wrap. A battery assembly jig for assembling the battery pack is also disclosed. The assembly jig is both modular and symmetrical, allowing the battery cells to be easily welded.

### TECHNICAL FIELD

The invention relates to a multi-cell battery pack, and to a jig for manufacturing the battery pack.

### BACKGROUND

A battery is an electrochemical cell that can store and discharge current at an operating voltage. Batteries are ubiquitous in modern life, found in everything from small consumer electronics to electric cars. Even if a system is powered in some other way, a battery or batteries may still be present as a backup, or to store generated power and provide it at a different time or in a different condition. For example, batteries are often present in solar power systems to store power as it is generated and to provide power when the sun is not available. As another example, uninterruptible power supplies (UPSes) are used with computer, Internet, and telecommunications infrastructure to provide power when a main power supply becomes unavailable or unsuitable for the needs of the equipment. In some data centers and other industrial settings, if the local electrical power grid fails, batteries may be used to supply power temporarily until backup electrical generators can be started.

The operating voltage of most battery cells is relatively low, usually on the order of a few volts, and each cell holds only a relatively small amount of current. Thus, the power that can be delivered by a single battery cell is small. Most devices require more power than a single battery cell can supply. Thus, many devices will use multiple battery cells connected together to supply the necessary power. If the number of battery cells is relatively few, a user may simply install those individual battery cells in a device one-by-one, as in the battery compartment of a flashlight or a portable music player. However, as the number of battery cells grows, dealing with those cells individually may be time consuming and inconvenient, and the amount of stored energy may require special handling precautions to prevent accidental discharge, fire, and other problems. In these situations, battery packs are frequently used.

A battery pack is an assemblage of individual battery cells along with other components needed to connect the battery cells together and to connect the battery pack to the device or devices that it is intended to power. Other components may be included to electrically insulate the battery cells, to prevent accidental discharges, and to allow the health and performance of the battery cells to be monitored, either individually or collectively.

In a typical battery pack, the terminals of the battery cells are tack-welded together. Electrically, the individual cells are usually placed in series with one another, which increases the output voltage of the battery pack, but series-parallel combinations may be used, because parallel connections between subsets of cells increase the current storage capacity of the battery pack for a particular voltage. The tack-welded battery cells are then placed in an enclosure or casing, which is typically rigid.

While battery packs are effective, the physical assembly of battery packs and their maintenance can be problematic. The sheer number of cells in a battery pack makes assembly a daunting challenge, particularly in placing and preparing battery cells for welding to electrical contacts. Additionally, the failure of a single battery cell within a battery pack can cause that battery pack to perform sub-optimally or to fail entirely. Yet battery packs are generally not assembled in ways that make them easy to disassemble. This makes it hard to diagnose and replace failing battery cells, and discarding an entire battery pack is undesirable and often infeasible.

### BRIEF SUMMARY

One aspect of the invention relates to a battery pack. The battery pack comprises a plurality of battery cells. Each of the battery cells has an anode and a cathode on opposite faces thereof. Opposite inner insulation layers cover the anodes and the cathodes of the plurality of battery cells. The inner insulation layers have openings provided to expose the anodes and the cathodes to allow for electrical connection. Opposite sets of one or more foils are electrically connected to the anodes and the cathodes of the plurality of battery cells over the inner insulation layers so as to connect the plurality of battery cells in series, in parallel, or in some combination of series and parallel to produce a collective power. At least one set of battery pack terminals is electrically and mechanically connected to the opposite sets of one or more foils to receive and convey at least some of the collective power of the plurality of battery cells. A flexible outer sheathing is secured around the plurality of battery cells to rigidify the battery pack.

Another aspect of the invention relates to a battery pack assembly jig. The jig comprises a lower plate, an upper plate, and a central bar. The lower plate, the upper plate, and the central bar are releasably connectable with one another in an I-beam configuration when connected.

The lower plate includes at least one battery compartment. The at least one battery compartment includes at least two through holes extending from an outer surface of the lower plate through to an inner surface of the lower plate. First engaging structures are associated with the at least two through-holes. The first engaging structures are constructed and adapted to engage and support a conductive foil in drop-in fashion over the at least two through-holes.

The upper plate has at least one access opening in a defined relationship relative to the at least one battery compartment of the lower plate. The at least one access opening extends from an outer surface through to an inner surface of the upper plate and has second engaging structures constructed and adapted to engage and support a conductive foil in drop-in fashion.

The battery pack assembly jig may be symmetrical about multiple axes, and the outwardly-facing surfaces of is upper and lower plates may be generally flat, with connecting structure recessed into the plates. This symmetry may provide advantages in manufacturing.

The battery pack assembly jig may be made of a thermoplastic, and the upper plate and the lower plate may each include two or more sections. In some cases, the assembly jig may be made by additive manufacturing.

Other aspects, features, and advantages of the invention will be set forth in the following description.

### BRIEF DESCRIPTION OF THE DRAWING FIGURES

The invention will be described with respect to the following drawing figures, in which like numerals represent like features throughout the description, and in which:

FIG. 1 is a perspective view of a battery pack according to an embodiment of the invention;

FIG. 2 is a perspective view similar to the view of FIG. 1, illustrating the battery pack with its outer sheathing removed to show certain internal details;

FIG. 3 is a front elevational view of the battery pack with sheathing removed;

FIG. 4 is an end elevational view of the battery pack with sheathing removed;

FIG. 5 is an exploded view of the battery pack;

FIG. 6 is a perspective view of a jig that can be used to assemble battery packs like the battery pack of FIGS. 1-5;

FIG. 7 is an end-elevational view of the jig; and

FIG. 8 is an exploded perspective view illustrating the placement of the components of a battery pack in the jig.

### DETAILED DESCRIPTION

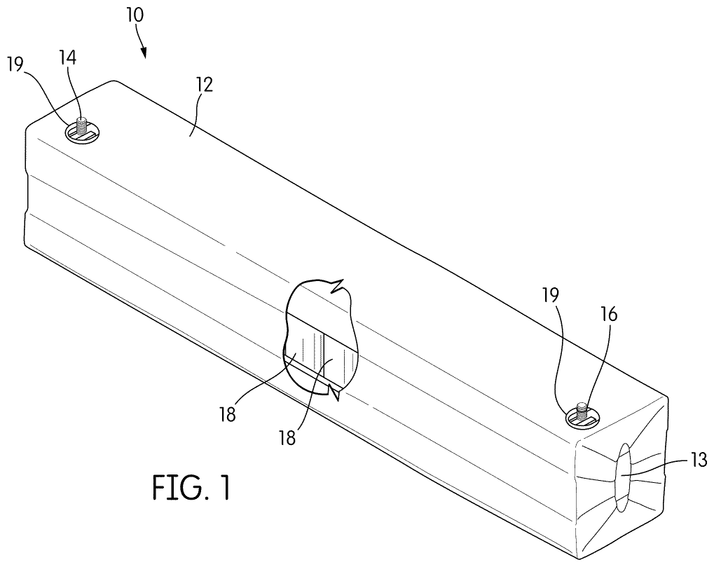

FIG. 1 is a perspective view of a battery pack, generally indicated at 10, according to one embodiment of the invention. The battery pack 10 is covered by an outer sheathing 12 that leaves only anode and cathode terminals 14, 16 visible. In the view of FIG. 1, the sheathing 12 is illustratively cut away to show that the battery pack 10 comprises a number of individual battery cells 18.

As used here, the term “battery pack” refers to an assemblage of individual battery cells that are electrically and mechanically connected together to operate collectively. A battery pack 10 may have as few as two battery cells 18 or as many battery cells 18 as are required to produce a particular output voltage or to store sufficient current for the application. For example, a typical battery pack might include 10-30 battery cells 18 electrically in series, in parallel, or in some combination of series and parallel. For example, subsets of two or four battery cells 18 may be connected electrically in parallel in a many-celled battery pack 10, with each subset of parallel-connected battery cells 18 connected to other subsets in series. The chemistry of the individual battery cells 18 is not critical and may be of any type, although much of this description will assume that the battery cells 18 are rechargeable, and certain portions of this description will assume that the battery cells 18 are of a lithium-based chemistry, e.g., lithium ferrophosphate, lithium iron phosphate (LFP), lithium nickel manganese cobalt oxide (NMC), or lithium nickel cobalt aluminum oxide (NCA). This description also assumes that the battery cells 18 are in a standard form and/or standard size. In this description, each of the battery cells 18 has a cylindrical form with the anode and cathode terminals 14, 16 disposed on opposite end faces.

As was described briefly above, battery packs 10 according to embodiments of the invention may be used in a vast number of applications, including consumer electronics; backup applications like uninterruptible power supplies (UPSes); power storage for power generating systems, like solar power systems; as direct primary power for electric vehicles, etc. Battery packs 10 for different applications may vary in the number of battery cells 18 that are used in the battery pack 10, in the type of battery cell 18, and in how those battery cells 18 are electrically connected together (i.e., in series, in parallel, or in some combination of series and parallel). Generally speaking, the disclosure provided here is equally applicable to battery packs 10 of all sizes and for all sorts of applications.

The outer sheathing 12 of the battery pack 10 is the primary mechanical support for the battery pack 10 and the primary means by which the individual cells 18 are held together. However, the outer sheathing 12 itself is not rigid. Rather, the outer sheathing 12 is thin and flexible, yet it binds the cells 18 together and harnesses their inherent rigidity in order to make the battery pack 10 a cohesive block. Thin films are particularly suitable for the outer sheathing 12. In the illustrated embodiment, the outer sheathing 12 comprises a tubular heat-shrink wrap that is slid over the assembled battery pack 10 and shrunk by application of heat (e.g., by hot air) until it is tensioned and taut against the battery cells 18. In other embodiments, other types of elements may be used as an outer sheathing 12, including various adhesive tapes and films, elastic bands, and the like.

There are several potential advantages to using thin films as the outer sheathing 12. First, such films are generally well-known, have been used widely in industry, behave in ways that are predictable, and are available in forms that would meet regulatory requirements for application in a battery pack 10. For example, heat shrink wraps that meet the flammability standards of UL 94 (UL, Inc., “Tests for Flammability of Plastic Materials for Parts in Devices and Appliances,” Standard 94, Edition 7, February 2023) are available. Thin films are also available in a variety of different sizes to accommodate battery packs 10 of different sizes. Finally, and as will be discussed below, should a battery pack 10 experience a cell failure or another type of maintenance problem, a thin-film outer sheathing 12 can easily be cut into and removed, exposing the problem and allowing for maintenance and repair. For example, as will be described below in more detail, a malfunctioning battery cell 18 can be easily removed and replaced. Once repairs are complete, new shrink wrap can be placed over battery pack 10 and shrunk into place as the outer sheathing 12.

The outer sheathing 12 will generally cover at least a portion of the battery pack 10, and it may cover substantially the entirety of the battery pack 10. However, the outer sheathing 12 need not cover the entirety of the battery pack 10 in all cases. As shown in FIG. 1, when the outer sheathing 12 is shrunk into shape around the battery pack 10, it may leave openings 13.

As can be seen in FIG. 1, the terminals 14, 16 in the illustrated embodiment are short, threaded posts. In other embodiments, any type of terminal 14, 16 may be used, so long as it can be used to make an electrical connection. As one of skill in the art might surmise, the terminals 14, 16 are usually made of copper or some other conductive metal, and they are thick enough (i.e., have enough ampacity) to carry the full current supplied by the battery pack 10, typically plus some safety margin. The outer sheathing 12 is cut or punched in the areas around the terminals 14, 16, leaving openings 19 that allow the terminals 14, 16 to protrude. As will be explained below in more detail, the outer sheathing 12 may be placed over the battery pack 10, including the terminals 14, 16 and then cut or punched to form the openings 19. While any form of cutting sufficient to penetrate the outer sheathing 12 will function to create openings 19, it may be helpful to punch the openings with a shaped tool, in order to avoid creating a tear that will enlarge or propagate over the life of the battery pack 10. In some cases, openings 19 may be punched before the outer sheathing 12 is shrunk and tensioned, but if that is done, care should be taken to ensure that the final openings 19 are properly sized, positioned, and dimensioned for the terminals 14, 16.

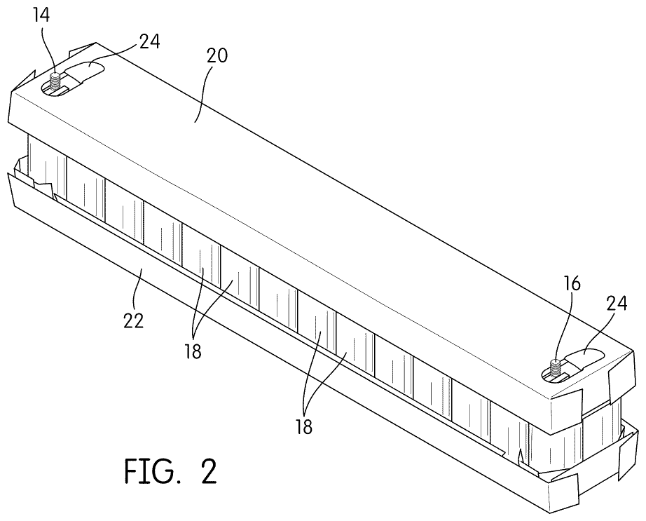

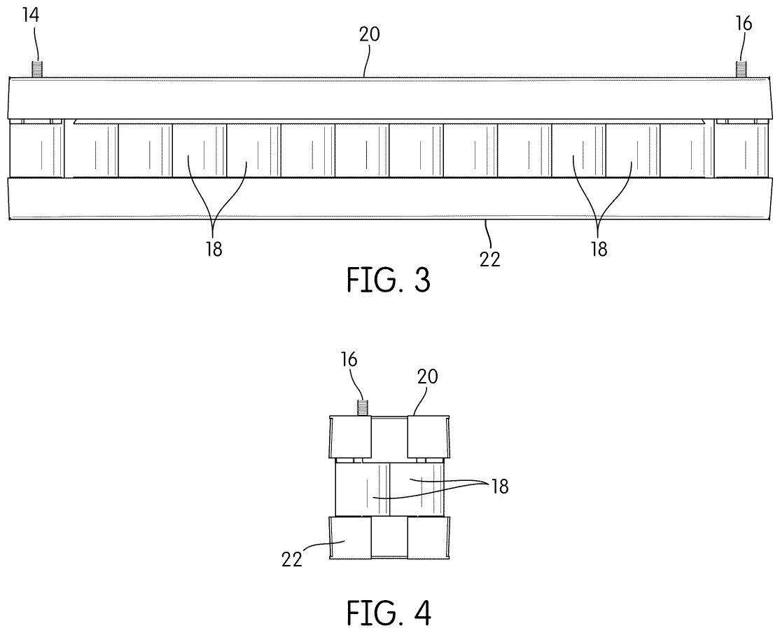

FIG. 2 is a perspective view of the battery pack 10 with the outer sheathing 12 removed to illustrate its interior arrangement, and FIGS. 3 and 4 are side elevational and end elevational views, respectively, of the battery pack 10. In this embodiment, the battery pack 10 has a width just greater than the width of two cells 18 placed side-by-side. The tops and bottoms of the cells 18, where their contact terminals are located, are covered by several layers of electrically insulative and fire-retardant material to prevent accidental discharges, sparks, and fires. The outer layers of material 20, 22 are visible in the views of FIGS. 2-4. In one embodiment, these layers of material 20, 22 may be insulation papers, such as NOMEX® 410 insulation paper (DuPont de Nemours, Inc., Wilmington, Delaware, United States). While other insulating and fire-retardant materials may be used, this kind of insulation paper has the advantages of being thin, light, and easily removed and replaced, which facilitates maintenance in the same way as the easily cut-and-replaced outer sheathing 12.

As can be appreciated from FIGS. 2-4, the insulation paper 20, 22 is not planar; rather, it is cut to a larger size and folded over the sides of the battery cells 18, such that the insulation papers 20, 22 together cover the tops and a substantial portion of the sides of the battery cells 18. However, as can be seen in FIG. 2, in the illustrated embodiment, the corners and edges of the insulation paper 20, 22 are not bonded or otherwise permanently secured. Instead, the corners are loose-when installed, the outer sheathing 12 keeps the insulation paper 20, 22 in shape and in place against the cells 18. Of course, if it is necessary or convenient, the insulation paper 20, 22 may have edges or corners that are bonded or otherwise secured to keep the insulation paper 20, 22 in a particular shape. Sheets of insulation paper 20, 22 may be cut or punched with any necessary or desirable features. As shown in FIG. 2, flaps 24 are cut or punched in the upper insulation paper 20 and folded back to allow the terminals 14, 16 to protrude.

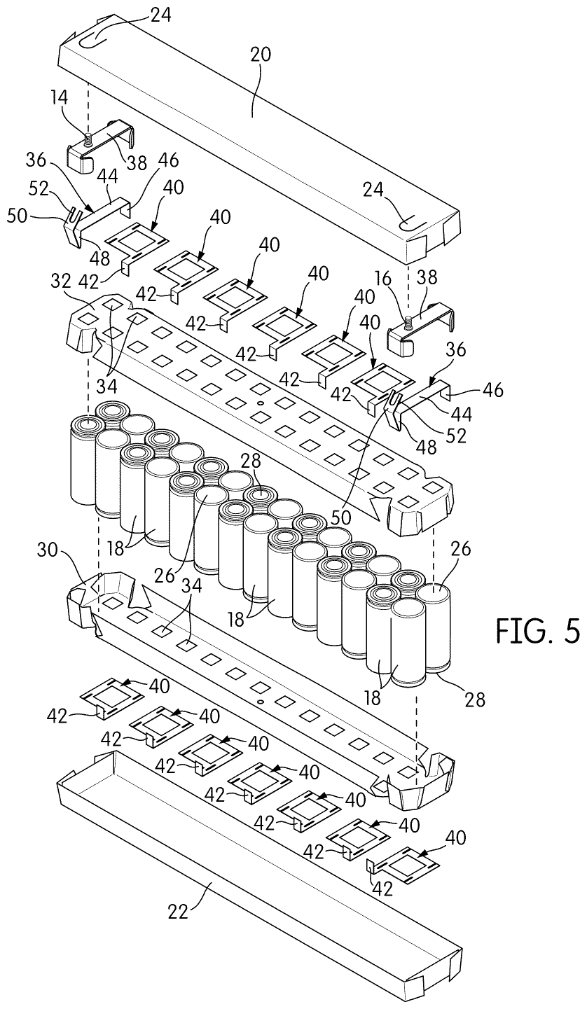

The full arrangement and configuration of the battery pack 10 can be appreciated from FIG. 5, an exploded perspective view showing all of the components except for the outer sheathing 12. The battery cells 18 are cylindrical in overall shape, with electrical terminals 26, 28 at the top and bottom faces. In this embodiment, the battery cells 18 are 26650 lithium iron phosphate cells, although the chemistry, style, size, and capacity of the cells 18 will vary from embodiment to embodiment.

Inner insulation papers 30, 32 are placed over the bottoms and the tops, respectively, of the battery cells 18. These inner insulation papers 30, 32 may be made of the same material as the outer layers of material 20, 22, and are folded down over the sides of the battery cells 18 much like the outer layers of material 20, 22. However, unlike the outer layers of material 20, 22, the inner insulation papers 30, 32 have cut openings 34 at predefined spacings that expose the terminals 26, 28 of the battery cells 18.

The inner insulation papers 30, 32, with their cut openings 34, help to ensure that although the terminals 26, 28 of the battery cells 18 are exposed for electrical connection, the areas between adjacent terminals 26, 28 are insulated, such that electrical shorts are less likely to develop. Additionally, the insulation papers 30, 32 may prevent sparks from spreading, either during welding or during operation of the battery pack 10.

The inner insulation papers 30, 32 and the outer layers of insulating material 20, 22 provide double insulation, making it less likely that sparks will catch, or a short circuit will occur. However, double insulation is optional; it may not be necessary in some applications. For example, in some applications and circumstances, it may be possible to omit the outer layers of insulating material 20, 22, particularly if the outer sheathing 12 has appropriate electrical insulating properties and fire-resistant or fire-retardant properties.

In the illustrated embodiment, thin conductive foils are used to connect the battery cells 18 in series, in parallel, or in some combination of series and parallel. The term “foil” is used here because, as a general matter, the foils have a much greater width and depth than their thickness. The foils used in embodiments of the invention are generally as thin as possible while still having the ampacity necessary to function in the battery pack 10 (i.e., they can carry the necessary current with some safety margin). The precise number and configuration of the foils will vary depending on the configuration of the battery pack 10. In typical embodiments, the foils may be, e.g., stamped and punched from sheet metal, although they may be made in other ways. The foils may be designed such that if the current or total power is over the safety margin, the foil will melt. This can be construed as a safety feature—e.g., in a short-circuit situation, the foils may act like fuses and melt, thereby disconnecting and remedying the short-circuit situation before a complete meltdown or total energy discharge.

In the illustrated embodiment of the battery pack 10, sets of two battery cells 18 are connected in parallel, and fourteen sets of two parallel-connected battery cells 18 are connected in series. Thus, the battery pack 10 has a total of 28 individual battery cells. To support this parallel-series connection scheme, the battery pack 10 of FIG. 5 uses two distinct types of foils. Specifically, atop the inner insulation paper 32 at each end of the battery pack 10, a bar foil 36 connects the last row of two end battery cells 18 in parallel. Each of the two bar foils 36 is adapted to connect electrically with a thicker metal bus bar 38 that lies overtop of the bar foil 36. The bus bars 38 carry the terminals 14, 16 that connect the battery pack 10 to its load or loads. As can be seen in FIG. 5, the bus bars 38 have depending portions that contour around the battery cells 18, improving the physical connection between the battery cells 18 and the bus bars 38.

The connections between most battery cells 18 are made by foils 40 that have the shape of a hollow square. These foils 40 are adapted to connect with four terminals 26, 28 simultaneously, one terminal 26, 28 at each corner of the hollow square of the foil 40, placing the two battery cells 18 in each row in parallel with one another, and placing each row of battery cells 18 in series with the row(s) adjacent to it. As can be seen in FIG. 5, six foils 40 are used atop the battery cells 18 on top, and seven foils 40 are used in the bottom of the battery cells 18. As will be described below in more detail, during assembly, the bar foil 36 and square foil 40 are tack-welded to the terminals 26, 28 of the battery cells 18 that lie beneath or overtop of them. Thus, in this embodiment, the last row of battery cells 18 at each end of the battery pack 10 has a bar foil 36 tack-welded to the top terminals 26, 28 and one-half of a square foil 40 tack-welded to the bottom terminals 26, 28.

Each of the square foils 40 has a protruding tab 42. The tabs 42 connect to wiring harnesses (not shown in the figures) and serve as low-current voltage taps for a battery monitoring system, i.e., to measure output voltage and other metrics indicative of battery cell 18 charge and health.

The bar foils 36 have a straight horizontal section 44 with a depending leg 46, 48 on each end. The horizontal section 44 is what is tack-welded to the upper terminals 26 through the openings 34 in the inner insulation paper 32. One depending leg 48 has a section 50 that folds back up and in, and terminates in a forked end 52 that fits over the top of the bus bar 38 and the terminal 12, 14 that is fixed to it. (In this case, the terminals 14, 16 are conductive threaded rods press-fit into appropriate openings in the bus bars 36.) The section 50 of the bar foil 36 that inserts over the terminals 14, 16 ensures secure electrical contact with the bus bar 38.

With this arrangement, should any of the battery cells 18 within the battery pack 10 require replacement, the outer sheathing 12 can be cut into to expose the battery cells 18. In typical embodiments, the foils 36, 40 are thin enough to be cut through with hand tools, e.g., wire cutters or sheet metal cutters, like tin snips. Thus, once the battery cells 18 and the foils 36, 40 are exposed, the foils 36, 40 can be cut through to release the affected battery cells 18 from the battery pack 10. New battery cells 18 can then be put in place and covered with new inner insulation papers 30, 32. The foils 36, 40 are thin enough that new foils 36, 40 can be welded overtop of the foils 36, 40 that were cut to remove the affected battery cells 18 without significantly affecting fit or performance. New outer sheathing 12 can then be installed.

If the battery pack 10 is particularly small, it may be possible to make an assemblage like that shown in FIGS. 1-5 without any special tooling or support structure. However, with almost any size of battery pack 10, it is generally useful to have some sort of jig or support.

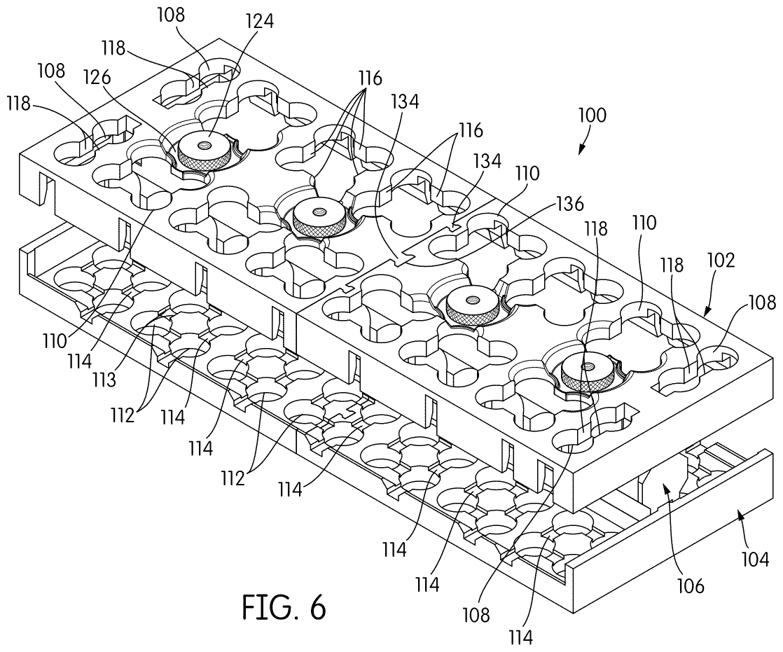

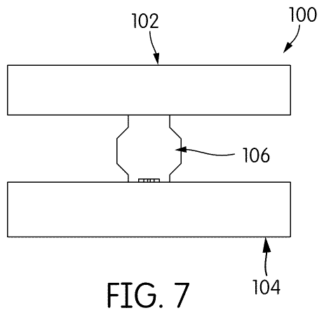

FIG. 6 is a perspective view of a jig, generally indicated at 100, for constructing a battery pack 10 like the one described above. The jig 100 of FIG. 6 has an upper plate 102 and a lower plate 104 with a central bar 106 sandwiched between them in an I-beam configuration. The I-beam configuration can be seen most clearly in FIG. 7, an end-elevational view of the jig 100, illustrating the relationship between the upper plate 102, lower plate 104 and central bar 106.

A jig 100 according to an embodiment of the present invention may be configured to make more than one battery pack 10 at once. This may improve the efficiency of manufacture. Moreover, there is no particular limit on the number of battery packs 10 that any one jig may be adapted to hold simultaneously for manufacture, although one would generally seek to keep the size and weight of a fully-loaded jig manageable. In the illustrated embodiment, the jig 100 is adapted to hold and make two battery packs 10 simultaneously, one battery pack 10 on each side of the central bar 106.

The upper plate 102 has openings 108, 110 adapted to expose the terminals 26, 28 of the battery cells 18 for welding. These openings 108, 110 generally correspond with the shape of the foils 36, 40 that are used to connect the battery cells 18. That is, the openings 108 allow access to the two parallel-connected battery cells 18 at each end of the battery pack; these are bar-shaped, broadening into circular areas to expose the terminals 26, 28 of the two battery cells 18. The remainder of the openings 110 in the upper plate 102 have a broad, cloverleaf shape, roughly rectangular, like the foils 40 they accommodate, with rounded corners that correspond to the shapes of the four battery cells 18 that the foils 40 connect. These openings 110 expose the terminals 26, 28 of four battery cells 18 and the foil 40 that is installed overtop of them so that the terminals 26, 28 of the four battery cells 18 can be welded to the foil 40.

The lower plate 104 has a shaped compartment 112 for each battery cell 18 that is accommodated by the jig 100. In the illustrated embodiment, the shaped compartments 112 are cylindrical, as the battery cells 18 are cylindrical.

The upper plate 102 and the lower plate 104 each have structure to accommodate foils 38, 40 and to ensure that those foils 38, 40 can be dropped into place and easily aligned. In the lower plate 104, a set of recesses 114 connects between the compartments 112. These recesses 114 include sets of flat, parallel sides 113, corresponding to the hollow square shape of the foils 40. The shape of the recesses 114 is such that a foil 40 dropped into them will be easily aligned with the terminals 28 to which it is intended to connect.

This feature—easy drop-in and alignment of foils 36, 48—is shared by the upper plate 102. The openings 110 of the upper plate 102 are more open than the corresponding structure on the lower plate 104 but have similar foil-alignment structure: inwardly-extending portions on each side that terminate in flat sides 116. The size of the openings 110 and the positions of the flat sides 116 are set so as to assist in the placement and alignment of the square foils 40. Similar flat sides 118 in the openings 108 are sized and arranged to align the bar foils 36.

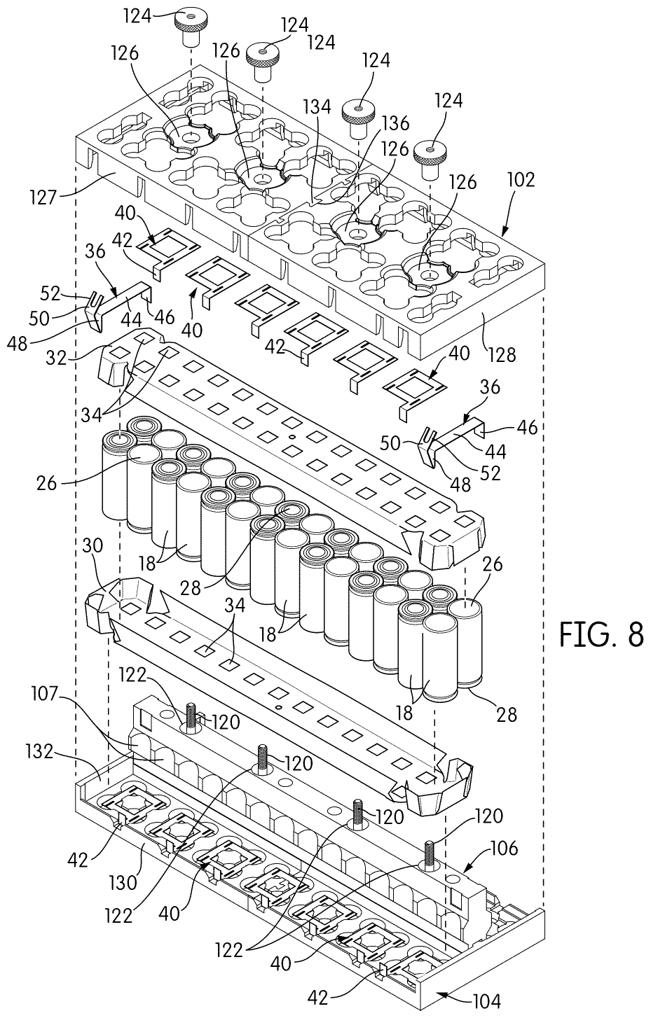

FIG. 8 is an exploded perspective view illustrating the jig 100 as used, showing how the components of the battery pack 10 are inserted into it. In FIG. 8, to avoid crowding the view, the components of only one battery pack 100 are shown, although the jig 100 can be used to assemble two battery packs simultaneously.

As can be appreciated from FIG. 8, the jig 100 itself is designed to be disassembled into its three major components 102, 104, 106. Bolts 120 insert through holes in the underside of the lower plate 104, and into corresponding, aligned holes 122 in the central bar 106. In the illustrated embodiment, there are four bolts 120 inserted through corresponding holes 122, although more or fewer may be used in other embodiments. On the top side of the upper plate 102, thumb nuts 124 are positioned to be inserted over the threaded ends of the bolts 122 to secure the components 102, 104, 106 of the jig 100 together. Recesses 126 are provided on the top side of the upper plate 102 for the thumb nuts 124. The recesses 126 are larger than the diameter of the thumb nuts 124 to allow the thumb nuts 124 to be manipulated with fingers. In fact, the recesses 126 intersect with the openings 110, reducing the wall height of the openings 110 at the positions of intersection.

With this configuration, one opens the jig 100 by removing the thumb nuts 124 and lifting the upper plate 102 from the central bar 106. The square foils 40 are dropped into the recesses 114 in the lower plate, aligned so that the tabs 42 protrude from the sides of the jig 100. The lower, inner insulation paper 30 is laid on top of the square foils 40, and the battery cells 18 are arranged on top of the inner insulation paper 30 so that their lower terminals 28 are accessible through the openings 34 in the lower, inner insulation paper 30. The upper, inner insulation paper 32 is laid overtop of the battery cells 18. The jig 100 is closed by installing the upper plate 102 and tightening the thumb nuts 124. The square and bar foils 36, 40 are laid overtop of the inner insulation paper 32 by dropping them into the openings 108, 110 in the upper plate 102 of the jig 100. The tabs 42 of the upper foils 40 also protrude from the side of the jig 100.

As shown in FIG. 8, in addition to its role connecting the upper plate 102 and the lower plate 104, the central bar 106 has substantial thickness, and on each side has an appropriately sized and shaped recess 107 for each battery cell 18. This is an optional feature but may aid in securing the battery cells 18.

Once the upper plate 102 is installed and the thumb nuts 124 are tightened, the battery cells 18 and other components are held in place in part by compressive force. Additionally, the upper plate 102 has depending sides 127, 128 that prevent the components from moving out of alignment in the jig 100, and the lower plate has corresponding upwardly-extending sides 130, 132. With the components properly arranged and the jig 100 closed, the foils 36, 40 can be tack-welded to the terminals of the battery cells 18 through the openings 110, 112.

To finish the assembly of the battery pack 10, the tabs 42 are connected to wires, e.g., by soldering. With the battery pack 10 removed from the jig 100, the outer insulation papers 20, 22 are installed, and the outer sheathing 12 is installed. If the outer sheathing 12 is shrink wrap, it would be slid over the battery pack 10 and then shrunk into place, as described above.

As may be apparent from FIGS. 6-8, when properly assembled and secured, the jig 100 holds the individual cells 18 in an arrangement that is symmetrical along X, Y, and Z axes. With reference to the coordinate system of the jig 100 itself, the jig 100 is symmetrical about its long axis and its short axis. If those two axes are defined as X and Y, the jig 100 is also symmetrical about the Z axis, i.e., an axis mutually perpendicular to X and Y.

Additionally, with the thumb nuts 124 recessed into the jig 100, both the top and bottom of the jig 100 are generally flat. These features may have any number of advantages in the manufacturing process. For example, an inexpensive and non-product-specific locating method can be used to position the jig 100 in a welding machine. Additionally, the same computer-numerically-controlled (CNC) welding program may be used to weld both the top and bottom sides of the jig 100. With the jig 100 and its symmetry, a jig 100 may be placed in a welding machine, have one side welded, be flipped over, and have the other side welded using the same locating structures.

The jig 100 itself is also designed to be modular, so as to be easily manufactured. The jig 100 may be made of a thermoplastic material, such as poly (lactic acid), poly (vinyl alcohol), polycarbonate, or acrylonitrile-butadiene-styrene (ABS) plastic by additive manufacturing (i.e., 3D-printing) or injection molding. As can be seen in FIGS. 6 and 8, the upper plate 102 and the lower plate 104 are designed to be manufactured in sections, and include cooperating engaging structure, like tongue 134 and groove 136 structure, to connect adjacent sections. This allows a jig 100 to be manufactured using an additive manufacturing system with a small working volume. In the illustrated embodiment, the upper plate 102 and the lower plate 104 are each comprised of two sections, although more or fewer sections may be used. Before the jig 100 is used, the sections can be bonded together by any number of techniques, including thermal fusing, solvent bonding, sonic welding, adhesives, and the like. In some cases, the sections may simply be made with very tight tolerances and press-fit together.

Of course, additive manufacturing and injection molding are not the only ways in which a jig 100 can be made, and neither the method of manufacture nor the material are particularly limited, although it may be helpful if the jig 100 is either made of an electrically insulative material or coated with one. Beyond thermoplastic manufacturing methods 100, a jig 100 may be cast, machined, stamped from sheet metal and bent into shape, etc. If the battery pack that is to be made is particularly large, or there are a number of battery packs, the upper and lower plates 102 104 could be made as single pieces to improve strength, or any joints between sections could be reinforced.

While the invention has been described with respect to certain embodiments, the description is intended to be exemplary, rather than limiting. Modifications and changes may be made within the scope of the invention, which is defined by the appended claims.

What is claimed is:

1. A battery pack, comprising:
a plurality of battery cells, each battery cell having an anode and a cathode on opposite faces thereof;
opposite inner insulation layers covering the anodes and the cathodes of the plurality of battery cells, the inner insulation layers having openings provided to expose the anodes and the cathodes to allow for electrical connection;
opposite sets of one or more foils electrically connected to ones of the anodes and the cathodes of the plurality of battery cells over the inner insulation layers so as to connect the plurality of battery cells in series, in parallel, or in some combination of series and parallel to produce a collective power;
at least one set of battery pack terminals electrically and mechanically connected to the opposite sets of one or more foils to receive and convey at least some of the collective power of the plurality of battery cells; and
a flexible outer sheathing secured around the plurality of battery cells to rigidify the battery pack.

2. The battery pack of claim 1, wherein each of the opposite sets of one or more foils further comprises a tab that serves as a low-current voltage tap.

3. The battery pack of claim 1, further comprising opposite outer insulation layers covering the opposite sets of one or more foils.

4. The battery pack of claim 3, wherein the opposite outer insulation layers comprise layers of insulation paper.

5. The battery pack of claim 1, wherein the opposite inner insulation layers comprise layers of insulation paper.

6. The battery pack of claim 1, wherein the flexible outer sheathing comprises shrink wrap.

7. The battery pack of claim 1, wherein the opposite sets of one or more foils comprise rectangular foils, open in the center.

8. The battery pack of claim 7, wherein the opposite sets of one or more foils comprise bar foils.

9. The battery pack of claim 1, wherein the set of battery pack terminals comprises rod or post terminals.

10. A battery pack assembly jig, comprising:
a lower plate having at least one battery compartment, the battery compartment including
at least two through-holes extending from an outer surface of the lower plate through to an inner surface of the top plate, and
first engaging structures associated with the at least two through-holes, the first engaging structures constructed and adapted to engage and support a conductive foil in drop-in fashion over the at least two through-holes;
an upper plate having at least one access opening in a defined relationship relative to the at least one battery compartment of the lower plate, the at least one access opening extending from an outer surface of the upper plate through to an inner surface of the upper plate and having second engaging structures constructed and adapted to engage and support a conductive foil in drop-in fashion; and
a central bar arranged between the lower plate and the upper plate;
wherein the lower plate, the central bar, and the upper plate are releasably connectable with one another such that the battery pack assembly jig has an I-beam configuration when the lower plate, the central bar, and the upper plate are connected; and
wherein the battery pack assembly jig is symmetrical about long and short axes thereof.

11. The battery pack assembly jig of claim 10, wherein the lower plate has upwardly-extending sides, and the upper plate has depending sides.

12. The battery pack assembly jig of claim 10, wherein the lower plate and the upper plate each comprise two or more sections with interengaging connecting structure.

13. The battery pack assembly jig of claim 10, wherein the interengaging connecting structure fits into recesses in one or both of the lower plate and the upper plate, such that outer surfaces of the lower plate and the upper plate are flat.

14. The battery pack assembly jig of claim 10, wherein the lower plate, the upper plate, and the central bar are made of a thermoplastic.

15. The battery pack assembly jig of claim 11, wherein the lower plate, the upper plate, and the central bar are made in sections and joined together.
